(19) United States
(12) Patent Application Publication
(10) Pub. No.: US 2008/0007126 A1
(43) Pub. Date: Jan. 10, 2008

(54) CLAW POLE STATOR FOR A STEPPING MOTOR AND CLAW POLE STEPPING MOTOR

(75) Inventors: Vladimir Vladimirovich POPOV, Villingen (DE); Helmut Schneider, Zimmern (DE)

Correspondence Address: Mark C. Comtois;Duane Morris LLP, Suite 700, 1667 K Street, N.W., Washington, DC, 20006, US

(73) Assignee: MINEBEA CO., LTD., Nagano (JP)

(21) Appl. No.: 11/750,899

(22) Filed: May 18, 2007

(30) Foreign Application Priority Data
Jun. 8, 2006 (DE) DE 102006026719.2

(51) Int. Cl. H02K 1/12; H02K 37/00

(52) U.S. Cl. 310/49 R; 310/257

(57) ABSTRACT

A claw pole stator for a stepping motor having at least a first and a second claw pole plate, each of which has a yoke and pole claws, the first and the second claw pole plate having the same number of pole claws and pole gaps and being coaxially disposed with respect to one another, wherein the pole claws of the first claw pole plate engage in the pole gaps of the second claw pole plate, and having a toroid coil that is located between the first claw pole plate and the second claw pole plate and at least the pole claws of the first claw pole plate being divided into several sections that comprise a first section that is connected to the yoke and is substantially trapezoidal in shape and tapered, narrowing with increasing distance from the yoke and that comprise a second section that adjoins the first section and is substantially rectangular in shape.

### CROSS REFERENCES

This application claims priority to the filing date of German Patent Application No. 10 2006 026 719.2 filed Jun. 8, 2006 the disclosure of which is incorporated herein by reference.

### BACKGROUND

The invention relates to a claw pole stator for a stepping motor having a first and a second claw pole plate, each of which has a yoke and pole claws, the first and the second claw pole plate having the same number of pole claws and pole gaps and being disposed coaxially with respect to one another such that the pole claws of the first claw pole plate engage in the pole gaps of the second claw pole plate. A toroid coil is inserted between the first and the second claw pole plate. A claw pole stator of this type is known from EP 1 513 242 A1.

In the prior art, various types of claw pole stepping motors are known. In a common design, this type of motor comprises an inner rotor and a first stator coil as well as a second stator coil that are usually arranged such that they enclose the outside circumference of the rotor. Claw pole stepping motors having this construction are known, for example, from EP 1 263 115 A2 or US 2002/0005670 A1. In this construction, the outside diameter of the permanent magnet is restricted by the inside diameter of the stator, so that particularly in the case of compact motors, the required torque or forces, such as are needed for an actuating drive, cannot be achieved.

EP 1 513 242 A1 thus proposes a motor structure in which the stator coils are arranged such that the rotor magnet lies between the coils in an axial direction. This motor has smaller radial dimensions than the motor described above. The two stators comprising the stator coils enclose the rotor from opposing end faces, the pole claws of the two stators that are disposed on the opposing end faces of the rotor extending in an axial direction along the circumference of the rotor and encompassing it like a cup.

The pole claws or pole bridges shown in EP 1 513 242 A1 are rectangular, whereas the pole claws of EP 1 263 115 A2 are trapezoidal. Tests undertaken by the inventor have found that neither of these pole claw shapes is ideal with respect to the magnetic properties of the stepping motor.

It is an object of the invention to provide a claw pole stator for a stepping motor that is optimized with respect to its magnetic properties. A particular object is to achieve relatively low saturation of the magnetic stator plate material and to provide for an improved build up of forces in the motor.

According to the invention, in a claw pole stator of the type mentioned at the outset, the pole claws of the first claw pole plate is divided into a plurality of sections. A first section or base section that is connected to the yoke is substantially trapezoidal in shape and tapered, narrowing with increasing distance from the yoke. A second section, or middle section, adjoins the base section and is substantially rectangular in shape. This second section may also be slightly trapezoidal in shape, the side edges of the second section being less inclined than the side edges of the first section. Thus in the context of this invention, the “substantially rectangular” shape of the second section of the pole claws comprises both a fully rectangular section as well as a section having slightly inclined side edges which tapers in the same direction as the first section but whose inclination is not as steep as that of the first, trapezoidal section. In the particularly preferred embodiment of the invention, a third section, or end section, of the pole claws adjoins the second section, this end section tapering off into a substantially triangular or curved shape. Here, the inclination of the side edges is steeper than in the first section. The free end may be pointed or slightly rounded.

According to the invention, the shape of the pole claws is optimized so as to achieve the best possible magnetic properties for the claw pole stepping motor. The first region comprises the base of the claw poles, by means of which the claw poles are connected to the yoke of the claw pole plate. This region can prevent saturation of the ferromagnetic claw pole material. In practice, a trapezoidal shape has proved suitable for this purpose, the wide base of which is connected to the yoke and which then tapers, narrowing with increasing distance from the yoke. The second section of the claw poles is located approximately at its center and has mainly parallel or slightly trapezoidal side edges. This section is narrower than the first section and represents an ideal compromise between the need for the greatest possible distance to the adjacent pole claw of the second claw pole plate, necessary in order to prevent large leakage flux, and the need to have the widest possible pole so as to prevent saturation of the magnetic material. The end of the pole claw is tapered and/or rounded and is preferably formed by a third section that is substantially triangular in shape. The point of the triangle may, but need not be rounded. The shape is made triangular in order to reduce cogging torque such as is produced in fully rectangular or slightly trapezoidal pole claws, as known in the prior art.

In an alternative embodiment of the invention, the pole claws of the first claw pole plate is divided into only two sections, namely a base section that is connected to the yoke and an end section that adjoins the base section. As in the first embodiment, the base section is substantially trapezoidal in shape and tapered, narrowing with increasing distance from the yoke. The end section is triangular or curved, it being understood that the term curved includes both parabolic or approximately parabolic shapes as well as trapezoidal or approximately trapezoidal shapes having a rounded end. The side edges of this end section have a different inclination than the side edges of the base section. On the one hand, the exact geometry of the base section and of the end section is dependent on the geometry of the pole claws of the second claw pole plate, and, on the other hand, on the magnetic properties that are to be achieved, particularly the low magnetic saturation of the pole claws and the systematic influencing of clogging torque. The shape of the end section corresponds substantially to the shape of the pole claws of the second claw pole plate.

In the preferred embodiment of the invention, the pole claws of the first and of the second claw pole plate are oriented in the same direction with regard to their respective yoke and are displaced with respect to each other in their phase by an electrical angle of 180°. In this arrangement, the first claw pole plate has longer pole claws, having the sections as described above, and the second claw pole plate has shorter pole claws. The pole claws of the second claw pole plate are preferably substantially triangular in shape.

In this embodiment, the first and the second claw pole plate are disposed with respect to one another such that the second section, or middle section, of the pole claws of the first claw pole plate lies at approximately the same height in an axial direction as the yoke of the second claw pole plate. Here, the second section of the pole claws of the first claw pole plate has approximately the same width in a circumferential direction as the pole claws of the second claw pole plate. This means that at the height of the yoke of the second claw pole plate “equivalent” pole claws are formed, i.e. pole claws that have the same properties with respect to the saturation of the magnetic material. The region in which the second claw pole plate is bent is located approximately at the height of the second section of the first claw pole plate. The short pole claws of the second claw pole plate correspond to the third section of the first claw pole plate in their given shape.

Whereas in the case of the first claw pole plate, the pole claws are widened at the height of the yoke such that they are wider than the corresponding pole gaps, in the case of the second claw pole plate, the pole gaps are wider in a circumferential direction than the corresponding pole claws. Here, the widening of the pole claws of the first claw pole plate is used to generate the lowest possible magnetic resistance, whereas the pole gaps of the second claw pole plate have to be wide enough to accommodate the pole claws of the first claw pole plate.

The invention also provides a claw pole stepping motor having a first and a second claw pole stator having the construction as described above, the two claw pole stators being coaxially aligned with respect to one another and their pole claws facing each other. A rotor is inserted between the pole claws of the first and of the second claw pole stator.

The invention is described in more detail below with reference to the drawings. The figures show:

### BRIEF DESCRIPTION OF THE DRAWING

FIG. 1 a first perspective view of the claw pole stator according to the invention;

FIG. 2 a second perspective view of the claw pole stator according to the invention;

FIG. 3 a schematic view of a long pole claw of the claw pole stator according to the invention;

FIG. 4 a schematic view of a long pole claw of the claw pole stator according to the invention in an alternative embodiment; and

FIG. 5 a perspective, exploded view of a claw pole stepping motor according to the invention.

### DETAILED DESCRIPTION

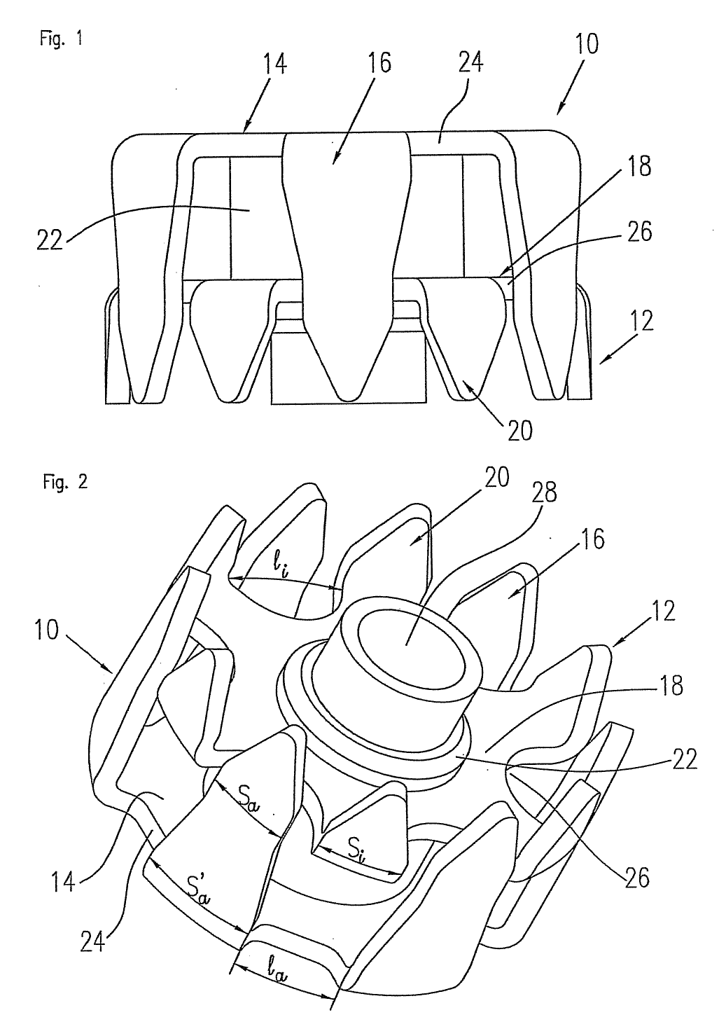

FIGS. 1 and 2 show a first and a second perspective view of the claw pole stator according to the invention, where the toroid coil is omitted for the sake of clarity. The stator comprises a first claw pole plate 10 and a second claw pole plate 12. The first claw pole plate 10 has an annular disk-shaped yoke 14 and a plurality of “long” pole claws 16. The pole claws 16 are distributed evenly about the circumference of the yoke 14 and are bent at an angle of 90° with respect to the yoke, so that the yoke 14 extends in a tangential direction of the stator, whereas the pole claws 16 extend in an axial direction. Like the first claw pole plate, the second claw pole plate 12 has an annular disk-shaped yoke 18 and a plurality of “short” pole claws 20. The number of pole claws 16, 20 and corresponding pole gaps of the first and of the second claw pole plate 10, 12 is identical, the pole claws 16 of the first claw pole plate 10 coming to lie between the pole claws 20 (in the pole gaps) of the second claw pole plate 12. The first claw pole plate 10 and the second claw pole plate 12 are connected to each other via a hub 22, the stator core also accommodating a toroid coil (not illustrated in FIGS. 1 and 2) that comes to lie between the first and the second claw pole plate 10, 12. Here, the hub 22 also has the task of conducting the magnetic flux induced by the coil, and is thus made of conductive magnetic material.

The first and the second claw pole plate 10, 12 are preferably punched out of a soft magnetic material, such as a galvanized steel plate, a silicon steel plate or from electromagnetic soft steel, the pole claws 16, 20 subsequently being bent at an angle of 90°. The claw pole plates are also referred to simply as pole plates in the prior art. The claw pole plates 10, 12 are magnetically connected to each other via the hub 22, the pole claws 16, 20 enclosing the rotor and being offset with respect to one another by an electrical angle of 180°. The hub 22 is likewise made of soft magnetic material and has a central aperture 28 for receiving the shaft (not illustrated in the figures).

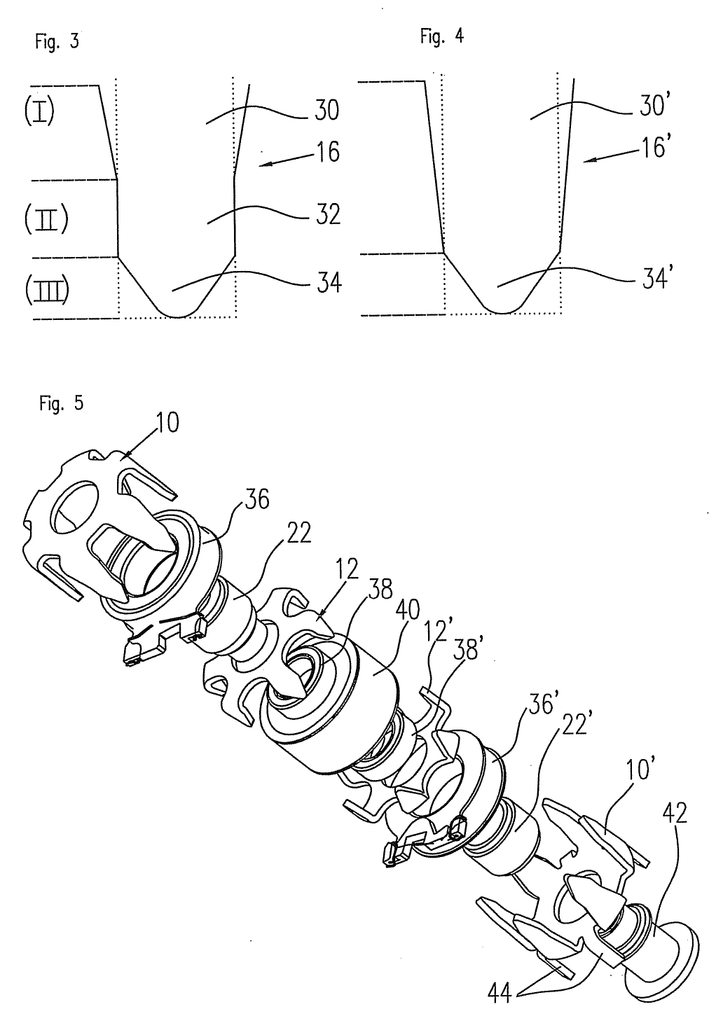

FIG. 3 shows an exemplary construction of a long pole claw 16 of the first claw pole plate 10. The pole claw 16 comprises a first section or base section 30 that abuts the yoke 14, an adjoining second section or middle section 32 as well as an adjoining third section or end section 34. The first section 30 is substantially trapezoidal in shape, the wide base of the trapezoid being connected to the yoke 14 and the section 30 being tapered, narrowing with increasing distance from the yoke. The adjoining second section 32 is substantially rectangular in shape. In this context, substantially rectangular means both perfectly rectangular as well as slightly trapezoidal, the side edges of the second section 32 not being as steeply inclined as the side edges of the first section 30. The adjoining third section is substantially triangular in shape or else it tapers off in a curve with the end being possibly rounded, although it is preferably pointed as sharply as possible. The sides delineating the triangle, or the curve respectively, are preferably more steeply inclined than the trapezoidal sides of the first section.

As illustrated in FIGS. 1 and 2, the first section 30 of the pole claws 16 extends from the yoke 14 of the first claw pole plate 10 approximately to the yoke 18 of the second claw pole plate 12. The second section 32 of the pole claw 16 is located at about the height of the yoke 18 of the second claw pole plate 12, and the third section 34 lies at the same height and has the same shape as the short pole claws 20 of the second claw pole plate 12. Furthermore, in the preferred embodiment of the invention, the following relative dimensions are preferably maintained. In the region of the second section 32, the long pole claws 16 are approximately as wide as the short pole claws 20 at their widest point; i.e. sₐ≈sᵢ. The pole gaps 26 between the short pole claws 20 are wider than the width of the corresponding short pole claws 20 at the height of the yoke 18; i.e. sᵢ<1ᵢ. At their widest point, the long pole claws 16 are wider than the corresponding pole gaps 24 between the pole claws 16; i.e. s′ₐ>1ₐ.

The stator arrangement according to the invention makes it possible to achieve the following effects and advantages. The first section or base section 30 of the long pole claws 16 is made as wide as possible in its bending region, where it is connected to the yoke 14, so as to generate the lowest possible magnetic resistance and to prevent saturation of the ferromagnetic claw pole material. This region is trapezoidal in shape because it is necessary to taper the pole claw at an increasing distance from the yoke 14 in respect of the pole gaps 26 of the second claw pole plate 12. The second section or middle section 32 of the long pole claws 16 can be largely parallel. The choice of width is a compromise between the need for the greatest possible distance to the adjacent pole claws 20 of the second claw pole plate 12, which is necessary to prevent leakage flux, and the need for the widest possible pole so as to prevent saturation of the magnetic material. The third section or end section 34 should be pointed as sharply as possible so as to reduce clogging torque which would otherwise be generated using a rectangular pole claw (dotted line in FIG. 3). The shape of the long pole claws according to the invention thus makes it possible to optimize the dynamic properties of the stepping motor.

FIG. 4 shows an exemplary construction of a long pole claw of the first claw pole plate in an alternative embodiment. The pole claw 16′ comprises a base section 30′ that abuts the yoke and an adjoining end section 34′. The base section 30′ is substantially trapezoidal in shape, the wide base of the trapezoid being connected to the yoke and the base section 30′ being tapered, narrowing with increasing distance from the yoke. The adjoining end section 34′ is substantially triangular in shape or tapers off in a curve with the end being possibly rounded, although it is preferably pointed as sharply as possible. The sides delineating the triangle, or the curve respectively, are preferably more steeply inclined than the trapezoidal sides of the base section 30′. Depending on the geometry of the pole claw 16′, however, they could also be less steeply inclined. In the illustrated embodiment, the base section 30′ of pole claw 16′ extends substantially over the same length as the first and second section 30, 32 of pole claw 16, i.e. from the yoke of the first claw pole plate until beyond the yoke of the second claw pole plate. The end section 34′ is located at the same height and has the same shape as the short pole claws 20 of the second claw pole plate. In an alternative embodiment not illustrated in the figures, the base section 30′ of pole claw 16′ may correspond substantially to the base section 30 of pole claw 16 from FIG. 3, with the end section 34′ being corresponding longer and its side edges having a gentler slope.

Substantially the same effects can be achieved with the embodiment of the pole claw 16 illustrated in FIG. 4 as with the pole claw design of FIG. 3. At all events, this second embodiment is somewhat inferior to the first embodiment only in relation to the optimal distance to the adjacent pole claws of the second claw pole plate and thus in relation to the prevention of leakage flux. The properties with respect to magnetic saturation and clogging torque are substantially the same, however.

FIG. 5 shows a perspective, exploded view of a claw pole stepping motor that is constructed using the claw pole stator according to the invention. In detail, FIG. 5 shows a first claw pole plate 10, a toroid coil 36, a hub 22 and a second claw pole plate 12 of a first claw pole stator according to invention. A first claw pole plate 10′, a hub 22′, a toroid coil 36′, a second claw pole plate 12′ and a spindle guide 42 of a second claw pole stator according to invention are disposed at the opposing end of the motor. The first and the second claw pole stator are coaxially disposed at the two end faces of the motor such that their pole claws point towards one another or are slightly offset radially. A rotor arrangement that is schematically shown by two ball bearings 38, 38′ and a rotor body 40 is located between the first and the second claw pole stator.

The claw pole plates 10, 12, 10′, 12′ and the toroid coils 36, 36′ are connected to each other via hubs 22, 22′ and joined to form a stator unit. Furthermore, the spindle guide 42 is provided on at least one axial end of the claw pole stator, the spindle guide being connected to the hub 22′ and the claw pole plate 10′ for the purpose of guiding a shaft or spindle through the two stator arrangements and the rotor. In the embodiment of FIG. 5, projecting lugs 44 for the purpose of connecting the motor to a flange (not illustrated) are moreover provided on the drive side of the claw pole plate 10′.

The coils 36, 36′ may have, for example, a spool carrier made of plastics on which a wire is wound that is led out via connector pins. The rotor 40 may have, as known in the prior art, a ring magnet, a plurality of individual magnets that are mounted on a rotor body or a rotor core having embedded magnets or any other suitable construction. The construction of the coils 36, 36′ and of the rotor 40 are not a subject matter of this invention.

All the components of the stepping motor shown in FIG. 5 have through holes used to mount them onto a (not illustrated) shaft or spindle. The characteristics revealed in the above description, the claims and the figures can be important for the realization of the invention in its various embodiments both individually and in any combination whatsoever.

Identification Reference List:
10, 10′ First claw pole plate
12, 12′ Second claw pole plate
14 Yoke of the first claw pole plate
16, 16′ Long pole claws
18 Yoke of the second claw pole plate
20 Short pole claws
22,22′ Hub
24 Pole gaps of the first claw pole plate
26 Pole gaps of the second claw pole plate
28 Aperture
30, 30′ First section, base section
32 Second section, middle section
34, 34′ Third section, end section
36, 36′ Toroid coil
38, 38′ Bearing
40 Rotor
42 Spindle guide
44 Lugs.

What is claimed is:

1. A claw pole stator for a stepping motor having at least a first and a second claw pole plate each of which has a yoke and pole claws , the first and the second claw pole plate having the same number of pole claws and pole gaps and being coaxially disposed with respect to one another, wherein the pole claws of the first claw pole plate engage in the pole gaps of the second claw pole plate, and having a toroid coil that is located between the first claw pole plate and the second claw pole plate, wherein at least the pole claws of the first claw pole plate are divided into several sections that comprise:
a first section that is connected to the yoke and is substantially trapezoidal in shape and tapered, narrowing with increasing distance from the yoke, and
a second section that adjoins the first section and is substantially rectangular in shape.

2. A claw pole stator according to claim 1, wherein the second section of the first claw pole plate is slightly trapezoidal in shape, the side edges of the second section having a slighter inclination than the side edges of the first section.

3. A claw pole stator according to claim 1, wherein the first claw pole plate comprises a third section that is substantially triangular or curved in shape adjoins the second section.

4. A claw pole stator according to claim 3, wherein the pole claws of the first and of the second claw pole plate are oriented in the same direction with regard to their respective yoke and are displaced with respect to each other in their phase by an electrical angle of 180°, the first claw pole plate having longer pole claws and the second claw pole plate having shorter pole claws.

5. A claw pole stator according to claim 4, wherein the shape of the pole claws of the second claw pole plate corresponds substantially to the shape of the third section of the first pole claw.

6. A claw pole stator according to claim 4, wherein the second section of the pole claws of the first claw pole plate lies at approximately the same level in an axial direction as the yoke of the second claw pole plate.

7. A claw pole stator according to claim 6, wherein the second section of the pole claws of the first claw pole plate has approximately the same width in a circumferential direction as the pole claws of the second claw pole plate at the level of the yoke of the second claw pole plate.

8. A claw pole stator for a stepping motor having at least a first and a second claw pole plate each of which has a yoke and pole claws, the first and the second claw pole plate having the same number of pole claws and pole gaps and being coaxially disposed with respect to one another, wherein the pole claws of the first claw pole plate engage in the pole gaps of the second claw pole plate, and having a toroid coil that is located between the first claw pole plate and the second claw pole plate, wherein at least the pole claws of the first claw pole plate are divided into several sections that comprise:
a base section that is connected to the yoke and is substantially trapezoidal in shape and tapered, narrowing with increasing distance from the yoke, and
an end section that adjoins the base section and is triangular or curved in shape, the side edges of the end section having a different inclination than the side edges of the base section.

9. A claw pole stator according to claim 8, wherein the pole claws of the first and of the second claw pole plates are oriented in the same direction with regard to their respective yoke and are displaced with respect to each other in their phase by an electrical angle of 180°, the first claw pole plate having longer pole claws and the second claw pole plate shorter pole claws.

10. A claw pole stator according to claim 9, wherein the shape of the pole claws of the second claw pole plate corresponds substantially to the shape of the end section of the first pole claw.

11. A claw pole stator according to claim 1, wherein the pole gaps of the second claw pole plate are wider in a circumferential direction than the pole claws of the second claw pole plate.

12. A claw pole stator according to claim 8, wherein the pole gaps of the second claw pole plate are wider in a circumferential direction than the pole claws of the second claw pole plate.

13. A claw pole stator according to claim 1, wherein the pole gaps of the first claw pole plate are narrower in a circumferential direction than the pole claws of the first claw pole plate at the level of the yoke of the first claw pole plate.

14. A claw pole stator according to claim 8, wherein the pole gaps of the first claw pole plate are narrower in a circumferential direction than the pole claws of the first claw pole plate at the level of the yoke of the first claw pole plate.

15. A claw pole stepping motor having a first claw pole stator and a second claw pole stator, each claw pole stator comprising:
at least a first and a second claw pole plate each of which has a yoke and pole claws, the first and the second claw pole plate having the same number of pole claws and pole gaps and being coaxially disposed with respect to one another, wherein the pole claws of the first claw pole plate engage in the pole gaps of the second claw pole plate, and having a toroid coil that is located between the first claw pole plate and the second claw pole plate, wherein at least the pole claws of the first claw pole plate are divided into several sections that comprise:
a first section that is connected to the yoke and is substantially trapezoidal in shape and tapered, narrowing with increasing distance from the yoke,
a second section that adjoins the first section and is substantially rectangular in shape, and
a third section that is substantially triangular or curved in shape adjoins the second section,
wherein the pole claws of the first and of the second claw pole plates are oriented in the same direction with regard to their respective yoke and are displaced with respect to each other in their phase by an electrical angle of 180°, the first claw pole plate having longer pole claws and the second claw pole plate having shorter pole claws; and wherein
the first and second claw pole stators are coaxially aligned with respect to one another in such a way that their claw poles face each other; and
having a rotor that is inserted between the claw poles of the first and second claw pole stators,
wherein the coils of the first and second claw pole stators are located on opposite sides of the rotor in an axial direction and wherein the claw poles of the first and second claw pole stators are located on an outer diameter of the stepping motor.

16. A claw pole stepping motor having a first claw pole stator and a second claw pole stator, each claw pole stator comprising:
at least a first and a second claw pole plate each of which has a yoke and pole claws, the first and the second claw pole plate having the same number of pole claws and pole gaps and being coaxially disposed with respect to one another, wherein the pole claws of the first claw pole plate engage in the pole gaps of the second claw pole plate, and having a toroid coil that is located between the first claw pole plate and the second claw pole plate, wherein at least the pole claws of the first claw pole plate are divided into several sections that comprise:
a base section that is connected to the yoke and is substantially trapezoidal in shape and tapered, narrowing with increasing distance from the yoke, and
an end section that adjoins the base section and is triangular or curved in shape, the side edges of the end section having a different inclination than the side edges of the base station;
wherein the pole claws of the first and of the second claw pole plates are oriented in the same direction with regard to their respective yoke and are displaced with respect to each other in their phase by an electrical angle of 180°, the first claw pole plate having longer pole claws and the second claw pole plate having shorter pole claws; and wherein
the first and second claw pole stators are coaxially aligned with respect to one another in such a way that their claw poles face each other; and
having a rotor that is inserted between the claw poles of the first and second claw pole stators,
wherein the coils of the first and second claw pole stators are located on opposite sides of the rotor in an axial direction and wherein the claw poles of the first and second claw pole stators are located on an outer diameter of the stepping motor.

17. A claw pole stator according to claim 4, wherein the pole claws of the first and second claw pole plates are configured in such a way that claw sections located at approximately the same level have corresponding shapes.

18. A claw pole stator according to claim 4, wherein the pole claws of the first and second claw pole plates are configured in such a way that claw sections located at approximately the same level have corresponding shapes.
